(19) United States
(12) Patent Application Publication
(10) Pub. No.: US 2007/0219675 A1
(43) Pub. Date: Sep. 20, 2007

(54) Driving control system

(75) Inventors: Isao Uchida, Tokyo (JP); Chiaki Itoh, Tokyo (JP); Chuji Akiyama, Tokyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 11/717,628

(22) Filed: Mar. 14, 2007

(30) Foreign Application Priority Data
Mar. 15, 2006 (JP) P.2006-070192

(51) Int. Cl. G06F 7/00

(52) U.S. Cl. 701/1; 701/36; 701/35

(57) ABSTRACT

A parameter storage section stores parameters to be used in electronic control units, in correlation with individual drivers. A driver identification section identifies a driver of a vehicle. A parameter retrieving section retrieves, from the parameter storage section, parameters correlated with the driver identified by the driver identification section, and supplies the retrieved parameters to the electronic control units. A parameter generation section generates parameters based on information related to the driver, and stores the generated parameters in the parameter storage section.

This application claims foreign priority based on Japanese Patent application No. 2006-070192, filed Mar. 15, 2006, the content of which is incorporated herein by reference in its entirety.

### BACKGROUND OF THE INVENTION

1. Field of the Invention

The present invention relates to a driving control system that employs electronic control units to control driving of a vehicle, and particularly, to a driving control system that can provide the driving control suitable for respective drivers.

2. Description of the Related Art

A system is known that adjusts a control state for an internal combustion engine in accordance with a driving operation of a driver, and enables the economical driving of a vehicle (see JP-A-10-217805). According to this system, vehicle's operation parameter signals are fed to a controller system 10, and based on this signal, the controller system 10 controls supply of fuel to an engine. At the same time, the control system monitors and records information related to the driving technique of the driver, and based on the recorded information, automatically determines the quantity of fuel to be supplied, thereby enabling economical driving.

Further, as a similar function related to the driving control, another system is known that provides a function of monitoring the temperature and the pressure of the atmosphere in a driving area and a quality of the fuel or the like, and automatically adjusting the quantity of fuel to be supplied and the ignition timing or the like. The intended purpose of this system is to make it possible that a vehicle which is adjusted to be an optimum state in a car maintenance facility provides good driving performance even when driving in a cold weather area or at high elevations.

In order to perform the above-described control, multiple control units, called electronic control units, are incorporated in a vehicle. These electronic control units are employed not only to control the engine, but also to control brakes, steering mechanism and safety devices, etc. Several tens of electronic control units are mounted in recent vehicles. As shown in FIG. 6, multiple electronic control units 15 are mounted inside the vehicle, and various sensors 16 are coupled to their input sides, while various actuators are coupled to their output sides. Since a microprocessor is mounted on many of the electronic control units 15, automatic adjustment of the driving state can be performed as described above, and states of the electronic control units 15 and self-diagnosis results can be transmitted via a communication bus 17.

In addition, as the intelligent operation of vehicles has been advanced, techniques for adapting vehicles to drivers have been developed. As one example case, a motor is employed to assist adjustment of longitudinal positioning, height and tilt, etc., of the driver's seat. A recent luxury grade vehicle has a function that stores positions of the driver's seat suitable for a plurality of drivers, and by pressing the driver's button, automatically shifts the driver's seat to the position stored for that driver.

According to the technique disclosed in JP-A-10-217805, the driving condition of the vehicle can be optimized automatically. However, since the data required for automatic adjustments are collected while actually driving, the driving condition of the vehicle can not be optimized immediately after start driving because the quantity of data is insufficient. That is, during this period, optimization of the driving condition is not possible. Further, when a driver is replaced during the course of a long trip, the optimized driving condition immediately after the driver change is one optimized for the previous driver, and an optimal driving condition can not immediately be provided for the new driver.

### SUMMARY OF THE INVENTION

The present invention has been made in view of the above circumstances, and provides a driving control system whereby am optimal driving condition can appropriately be provided for respective drivers.

In some implementations, a driving control system of the invention for controlling driving of a vehicle by using an electronic control unit, the driving control system comprising:

a parameter storage section for storing parameters to be used in the electronic control unit, the parameters being stored in correlation with a driver;

a driver identification section for identifying a driver of the vehicle; and

a parameter retrieving section for retrieving parameters that are correlated with the driver identified by the driver identification section, from the parameter storage section, and for supplying the retrieved parameters to the electronic control unit.

According to this driving control system, since parameters that are correlated with the driver identified by the driver identification section are retrieved from the parameter storage section and are supplied to the electronic control units, an optimal driving condition for the current driver can be appropriately achieved.

In the driving control system, the parameter storage section is provided outside the vehicle, and

the parameter retrieving section retrieves the parameters that are correlated with the driver identified by the driver identification section, from the parameter storage section via communication.

According to this driving control system, since parameters that are correlated with the driver identified by the driver identification section are retrieved from the parameter storage section via communication, and are supplied to the electronic control unit, an optimal driving condition for the current driver can be appropriately achieved.

In some implementations, a driving control system of the invention for controlling driving of a vehicle by using an electronic control unit, the driving control system comprising:

a parameter storage section for storing parameters to be used in the electronic control unit;

an insertion section to which the parameter storage section is removably inserted; and

a parameter retrieving section for retrieving the parameters from the parameter storage section inserted in the insertion section, and for supplying the retrieved parameters to the electronic control unit.

According to this driving control system, parameters are retrieved from the parameter storage section inserted in the insertion section and are supplied to the electronic control unit. Since the parameter storage section is inserted in the insertion section, a driving condition in accordance with the parameters stored in the parameter storage section can be achieved.

The driving control system may further comprise:

a parameter generation section for generating the parameters based on information related to the driver, and storing the generated parameters in the parameter storage section.

### BRIEF DESCRIPTION OF THE DRAWINGS

FIG. 1 is a block diagram showing a configuration of a vehicle to which a personalization unit is mounted as a driving control system according to a first embodiment of the present invention.

FIG. 2 is a flowchart showing an operation procedure of the personalization unit.

FIG. 3 is a block diagram showing a configuration of a vehicle to which a personalization unit is mounted as a driving control system according to a second embodiment of the present invention.

FIG. 4 is a block diagram showing a configuration of a vehicle to which a personalization unit is mounted as a driving control system according to a third embodiment of the present invention.

FIG. 5 is a flowchart showing an operation procedure of the personalization unit.

FIG. 6 is a diagram showing a structure of a vehicle that employs electronic control units.

### DESCRIPTION OF THE PREFERRED EMBODIMENTS

A driving control system will be explained according to the embodiments of the present invention.

### First Embodiment

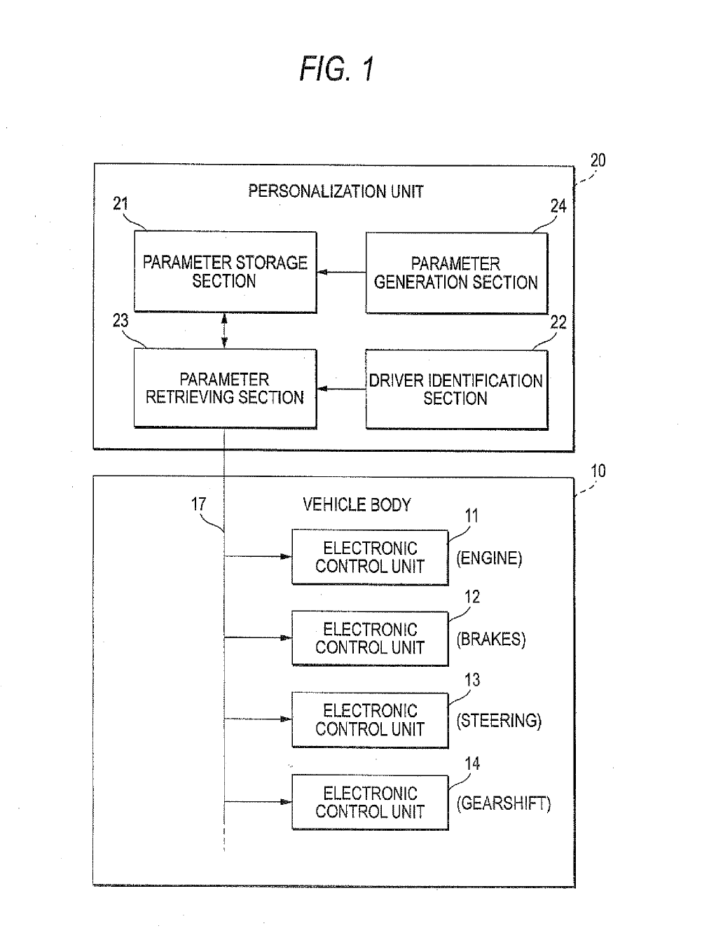

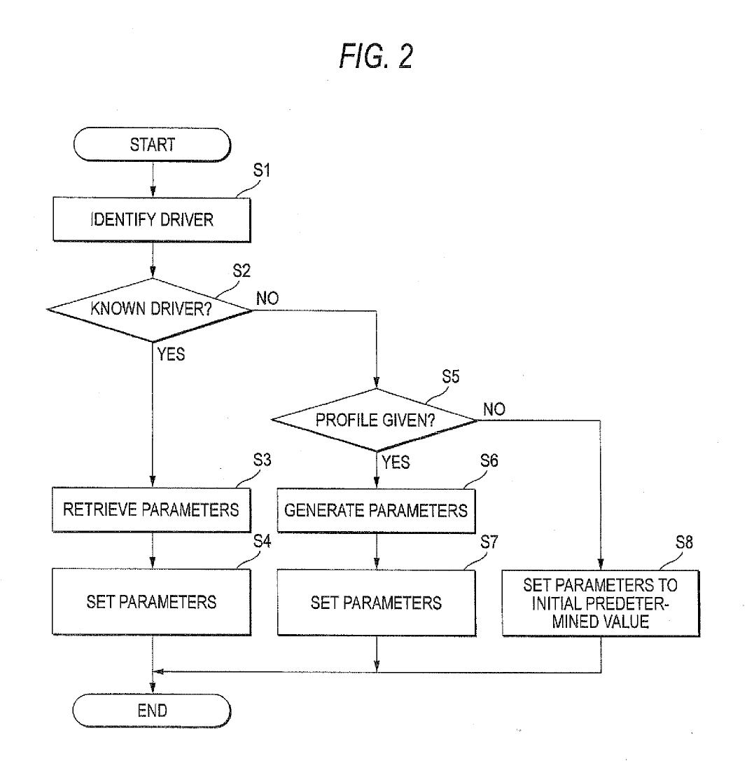

A driving control system according to a first embodiment of the present invention will now be explained while referring to FIGS. 1 and 2.

FIG. 1 is a block diagram showing the configuration of a vehicle to which a personalization unit is mounted as the driving control system of this embodiment.

As shown in FIG. 1, multiple electronic control units, including electronic control units 11 to 14 that perform the control of engine, brakes, steering and gearshift, etc., are mounted in a vehicle body 10.

The personalization unit 20 can be attached to an existing vehicle body 10. The electronic control units are connected to the personalization unit 20 via a communication bus 17.

The personalization unit 20 includes: a parameter storage section 21 for storing parameters to be used in the electronic control units 11 to 14, in correlation with drivers; a driver identification section 22 for identifying a driver of a vehicle; a parameter retrieving section 23 for retrieving parameters that are correlated with the driver identified by the driver identification section 22 from the parameter storage section 21, and for supplying the parameters to the electronic control units 11 to 14; and a parameter generation section 24 for generating parameters based on information related to a driver, and for storing the generated parameters in the parameter storage section 21.

In the parameter storage section 21, for a plurality of drivers, parameter groups to be used in the electronic control units 11 to 14 are stored in correlation with the individual drivers.

The driver identification section 22 includes, for example, a switch for accepting an operation by a driver. The driver can select himself/herself by manipulating the switch, and in accordance with this manipulation, the driver is identified. Further, an operation panel or the like may be provided with which the driver can give a code, etc., and the given code, etc., can be used to identify the driver.

The driver identification section 22 may identify the driver by using hardware such as an ID card of the driver, or a biometric identity verification of a fingerprint, a palmprint, an iris scan or a voiceprint, etc. When driver's licenses are made electronic in the future, for example, the driver's license may be used as the ID card of the driver.

The parameter generation section 24 includes, for example, an input device for accepting an operation from a driver or the like. The parameter generation section 24 performs a computation based on attributes (profile) of the driver inputted by the input device, for example, to generate the optimal parameters for the profile. Age, sex and driving experience of the driver can be exemplified as the attributes of the driver.

FIG. 2 is a flowchart showing the operation procedure of the personalization unit 20. This processing is initiated when the vehicle power is switched on, or the engine is started, for example.

If the release of the brakes or the accelerator operation is inhibited by an instruction to the electronic control units 11 to 14, during a period until a parameter group is supplied to the electronic control units 11 to 14, more safety can be assured.

At step S1 in FIG. 2, the driver identification section 22 identifies a driver. At step S2, a check is performed to determine whether the driver identified at step S1 is the known driver previously registered in the parameter storage section 21. When the determination is affirmative, the process goes to step S3. When the determination is negative, the process goes to step S5.

At step S3, the parameter retrieving section 23 retrieves from the parameter storage section 21 a parameter group correlated with the identified driver. Then, at step S4, the parameter retrieving section 23 transmits the retrieved parameter group to the electronic control units 11 to 14, and the process is terminated. As a result, the parameters are supplied to the electronic control units 11 to 14, and vehicle driving is enabled. In this case, since the parameter group previously stored in the parameter storage section 21 is employed, driving control in accordance with the profile of the driver is performed.

At step S5, a check is performed to determine whether the input operation of the profile of the driver is performed. When the determination at step S5 is affirmative, the process goes to step S6, or when the determination at S5 is negative, the process goes to step S8.

At step S6, the parameter generation section 24 performs a computation based on the given profile of the driver, and generates a group of parameters. The generated parameter group is stored in the parameter storage section 21, in correlation with the identified driver. Thus, the driver is registered in the parameter storage section 21, and after that, an affirmative determination will be acquired at step S2.

Sequentially, at step S7, the parameter retrieving section 23 transmits the parameter group generated at step S6 to the electronic control units 11 to 14, and the process is thereafter terminated. Since the parameters are supplied to the electronic control units 11 to 14, driving of the vehicle is enabled. In this case, driving control in accordance with the profile of the driver is performed.

At step S8, a predetermined default values are set for the parameter group, and the parameter retrieving section 23 transmits the parameter group to the electronic control units 11 to 14. Thereafter, the process is terminated. Since the parameters are supplied to the electronic control units 11 to 14, driving of the vehicle is enabled. In this case, driving control is performed by using the default values, regardless of the driver. General purpose parameters can be employed as the default values.

In this embodiment, since driving control in the electronic control units 11 to 14 is performed by employing the parameter group stored for each driver, an optimal driving control according to the profile of a driver can be achieved. Further, the parameter group that corresponds to the profile of a driver is stored in advance in the parameter storage section 21, and from the beginning of driving, driving control is performed by using the parameter group stored in the parameter storage section 21. Thus, an optimal driving condition for the driver can be achieved immediately after starting driving.

The results of the automatic parameter adjustment by the electronic control units 11 to 14 may be reflected on the parameters to be stored in the parameter storage section 21. For example, the parameter group, on which the automatic adjustment results of parameters based on the monitoring of way of driving and the driving experience by the electronic control units 11 to 14 are reflected, may be uploaded to the parameter storage section 21 when ending the driving, or when the engine is stopped or the like. In this case, an automatic parameter adjustment is performed for each driver, and the automatic adjustment results are managed for the individual drivers, so that problems can be avoided that may occur when a plurality of drivers are to drive the same vehicle.

As a parameter setting method based on the profile of a driver, a method according to an arbitrary purpose such as assuring of safety driving or improvement in fuel efficiency can be employed. Algorithms for determining parameters that correspond to a plurality of purposes may be prepared, so that the driver can select one of the purposes, and parameters can be calculated based on the algorithm corresponding to the selected purpose.

### Second Embodiment

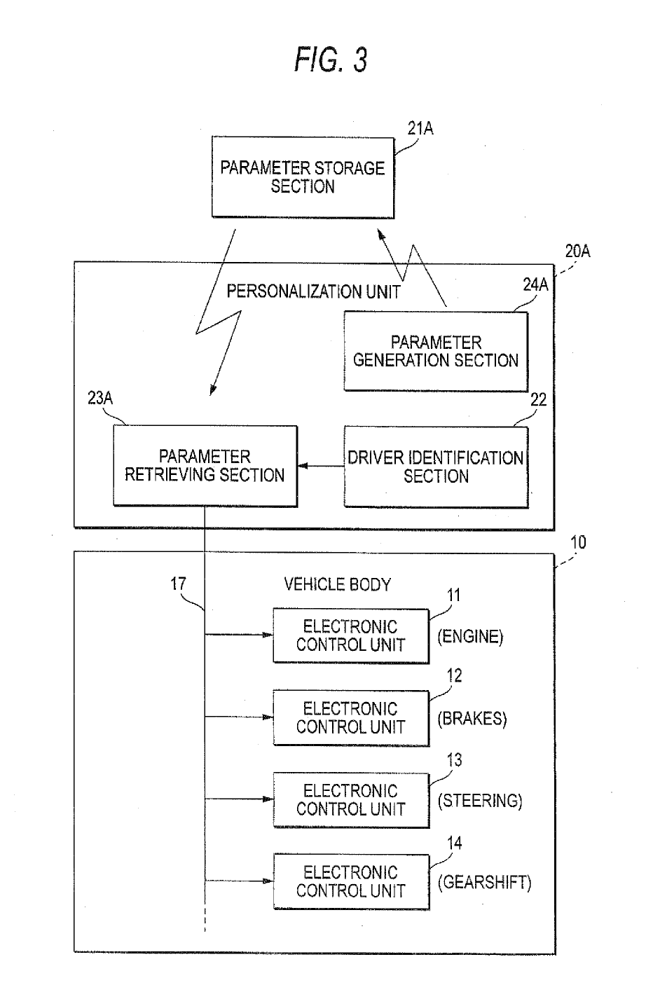

A driving control system according to a second embodiment of the present invention will now be described while referring to FIG. 3. According to an example for the second embodiment, a parameter storage section is provided outside a vehicle.

FIG. 3 is a block diagram showing the configuration of a vehicle to which a personalization unit is mounted as the driving control system of the embodiment. The same reference numerals as in FIG. 1 are provided for the same components as in the first embodiment, and no further explanation for them will be given.

As shown in FIG. 3, a personalization unit 20A includes: a driver identification section 22 for identifying a driver of a vehicle; a parameter retrieving section 23A for retrieving parameters that are correlated with the driver identified by the driver identification section 22, from a parameter storage section 21A provided outside the vehicle via communication, and for supplying the parameters to the electronic control units 11 to 14; and a parameter generation section 24A for generating parameters based on information related to a driver and for storing the generated parameters in the parameter storage section 21A.

The parameter storage section 21A can be a server that is connected to the personalization unit 20A, for example, by radio, via a public network, or via a local or wide area network that uses the Internet or the like. In the parameter storage section 21A, as for a plurality of drivers, parameter groups to be used in the electronic control units 11 to 14 are stored in correlation with the individual drivers.

As shown in FIG. 3, the parameter storage section 21A can communicate with the parameter retrieving section 23A and the parameter generation section 24a via a network. Therefore, as in the first embodiment, the parameter group stored in the parameter storage section 21A can be retrieved through the parameter retrieving section 23A. Furthermore, the parameter group generated by the parameter generation section 24A can be stored in the parameter storage section 21A.

In this embodiment, a parameter group to be used in the electronic control units 11 to 14 is retrieved via communication from the parameter storage section 21A. Thus, for all the vehicles on which personalization units 20A can be mounted and in which the parameter group can be used in the same manner, driving control that employs parameters associated with each driver can be enabled. Therefore, an appropriate driving condition can always be achieved even when a different vehicle is driven.

Furthermore, for all these vehicles, parameters can be generated by the parameter generation section 24A, and the generated parameters can be stored in the parameter storage section 21A.

As described above, in this embodiment, since the driving control in the electronic control units 11 to 14 is performed by employing a parameter group stored for each driver, an optimal driving control corresponding to the profile of a driver can be achieved. Further, a parameter group that matches the profile of a driver is stored in advance in the parameter storage section 21A, and from the beginning of driving, driving control using the parameter group stored in the parameter storage section 21A is performed. Therefore, an optimal driving condition for a driver can be achieved immediately after driving is started.

As in the first embodiment, automatic parameter adjustment results by the electronic control units 11 to 14 may be reflected on the parameters stored in the parameter storage section 21A.

### Third Embodiment

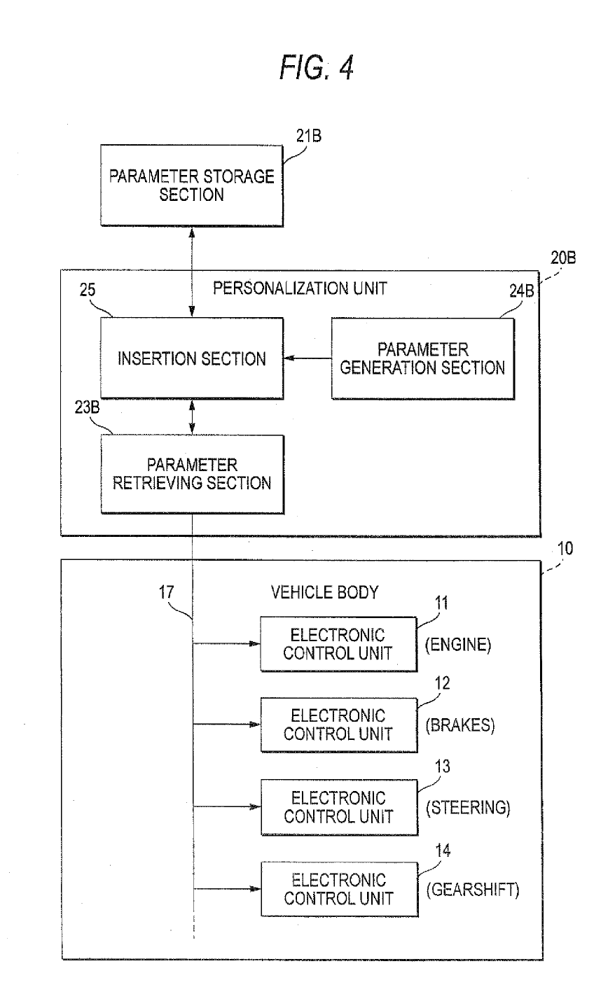

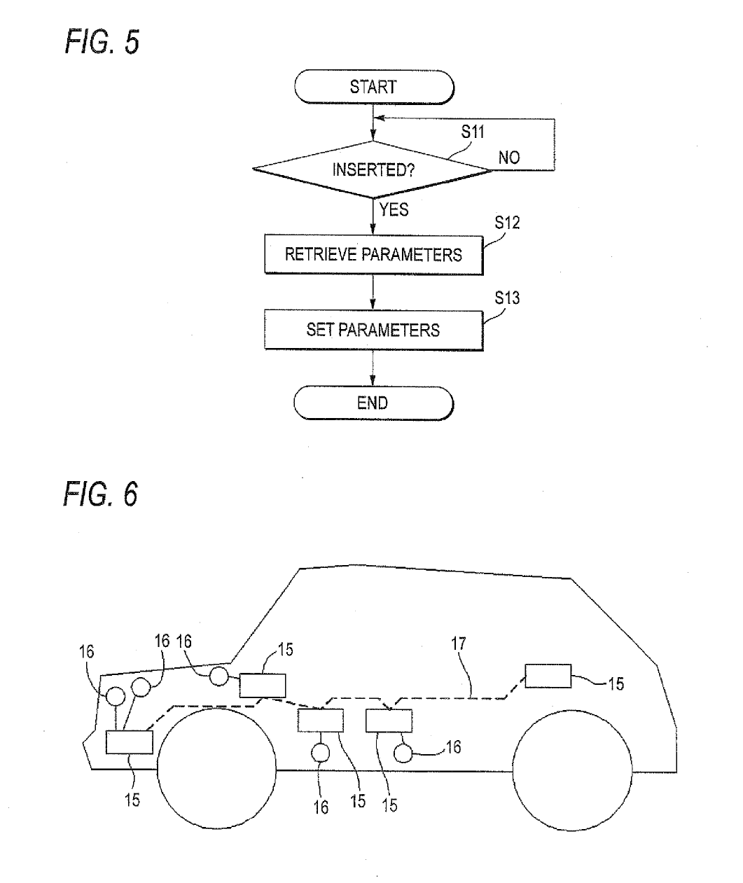

A driving control system according to a third embodiment of the present invention will now be described while referring to FIGS. 4 and 5. According to an example in the third embodiment, a portable parameter storage section is employed.

FIG. 4 is a block diagram showing the configuration of a vehicle to which a personalization unit is mounted as the driving control system of this embodiment. The same reference numerals as in FIG. 1 are provided for the same components as in the first embodiment, and no further explanation for them will be given.

As shown in FIG. 4, a personalization unit 20B includes: an insertion section 25 to which a parameter storage section 21B is removably inserted; a parameter retrieving section 23B for retrieving parameters from the parameter storage section 21B inserted in the insertion section 25 and for supplying the parameters to the electronic control units 11 to 14; and a parameter generation section 24B for generating parameters based on information related to drivers and for storing the generated parameters in the parameter storage section 21B.

The parameter storage section 21B can be a memory incorporated in a card or a key, for example, carried by an individual driver. In this case, a parameter group to be used in the electronic units 11 to 14 for an individual driver carrying the card or the key is stored in the parameter storage section 21B.

FIG. 5 is a flowchart showing the operation procedure of the personalization unit 20B.

At step S11 in FIG. 5, a check is performed to determine whether the parameter storage section 21B is inserted in the insertion section 25. After the determination has become affirmative, the process goes to step S12.

At step S12, the parameter retrieving section 23B retrieves a parameter group from the parameter storage section 21B inserted in the insertion section 25. At step S13, the parameter retrieving section 23B transmits the retrieved parameter group to the electronic control units 11 to 14, and the process is terminated. Sine the electronic control units 11 to 14 are supplied with the parameters, the driving of a vehicle is enabled.

As described above, in this embodiment, the parameter storage sections 21B are prepared wherein parameter groups are stored for the individual drivers, and by inserting this parameter storage section 21B into the insertion section 25, the parameters for a current driver are supplied to the electronic control units 11 to 14. Thus, for all the vehicles on which personalization units 20B are mounted, and in which parameter groups can be employed in the same manner, driving control using the parameters correlated with the individual drivers can be performed. Therefore, when a different vehicle is driven, an optimal driving condition can always be achieved.

Furthermore, when the parameter storage section does not contain parameters of the driver for all these vehicles, parameters can be generated by the parameter generation section 24B, and the generated parameters can be stored in the parameter storage section 21B.

In this embodiment, since parameters stored in the parameter storage section 21B need not be correlated with the driver, the process to identify the driver before starting driving is not required.

As described above, in this embodiment, since the driving control in the electronic control units 11 to 14 is performed by using a parameter group stored for each driver, an optimal driving control corresponding to the profile of a driver can be achieved. Furthermore, the parameter group that matches the profile of a driver is stored in advance in the parameter storage section 21B, and from the beginning of driving, driving control is performed by using the parameter group stored in the parameter storage section 21B. Therefore, an optimal driving condition for a driver can be achieved immediately after driving is started.

As in the first embodiment, the automatic parameter adjustment results by the electronic control units 11 to 14 may be reflected on the parameters to be stored in the parameter storage section 21B.

In this invention, parameters stored in the parameter storage section either may be parameters directly used in the electronic control units, or may be parameters that are not directly used in the electronic control units, but other parameters that are used to calculate the parameters that are directly used in the electronic control units by computation or the like. For example, parameters indicating the profile of a driver may be stored. In this case, by using a predetermined algorithm, the parameters indicating the profile of the driver are converted into parameters to be directly used in the electronic control units, and the parameters are supplied to the electronic control units. As described above, in this embodiment, “parameters” are not limited to “parameters to be directly used in the electronic control units”.

Further, the generation of parameters is not limited to the generation of parameters in accordance with an instruction from a driver. For example, in a distributor or a maintenance facility, an optimal parameter group for a customer to be the driver in the future can be generated and stored in the parameter storage section. At this time, when replies of the customer to a questionnaire survey or driving data of the driver during trial driving of the simulator or the actual car are employed for generation of the optimum parameter group, parameters more appropriate for the driver can be generated.

As explained above, according to this driving control system, since parameters that are correlated with the driver identified by the driver identification section are retrieved from the parameter storage section and are supplied to the electronic control units, an optimal driving condition for the current driver can be appropriately achieved. (first embodiment).

Furthermore, according to this driving control system, since parameters that are correlated with the driver identified by the driver identification section are retrieved from the parameter storage section via communication, and are supplied to the electronic control unit, an optimal driving condition for the current driver can be appropriately achieved (second embodiment).

Further, according to this driving control system, parameters are retrieved from the parameter storage section inserted in the insertion section and are supplied to the electronic control unit. Since the parameter storage section is inserted in the insertion section, a driving condition in accordance with the parameters stored in the parameter storage section can be achieved (third embodiment).

The scope where the present invention is applied is not limited to these embodiments. The present invention is widely applicable to a driving control system that performs control of the vehicle driving by employing electronic control units.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A driving control system for controlling driving of a vehicle by using an electronic control unit, the driving control system comprising:
a parameter storage section for storing parameters to be used in the electronic control unit, the parameters being stored in correlation with a driver;
a driver identification section for identifying a driver of the vehicle; and
a parameter retrieving section for retrieving parameters that are correlated with the driver identified by the driver identification section, from the parameter storage section, and for supplying the retrieved parameters to the electronic control unit.

2. The driving control system according to claim 1, wherein the parameter storage section is provided outside the vehicle, and
the parameter retrieving section retrieves the parameters that are correlated with the driver identified by the driver identification section, from the parameter storage section via communication.

3. A driving control system for controlling driving of a vehicle by using an electronic control unit, the driving control system comprising:
a parameter storage section for storing parameters to be used in the electronic control unit;
an insertion section to which the parameter storage section is removably inserted; and
a parameter retrieving section for retrieving the parameters from the parameter storage section inserted in the insertion section, and for supplying the retrieved parameters to the electronic control unit.

4. The driving control system according to claim 1, further comprising:
a parameter generation section for generating the parameters based on information related to the driver, and storing the generated parameters in the parameter storage section.

5. The driving control system according to claim 2, further comprising:
a parameter generation section for generating the parameters based on information related to the driver, and storing the generated parameters in the parameter storage section.

6. The driving control system according to claim 3, further comprising:
a parameter generation section for generating the parameters based on information related to the driver, and storing the generated parameters in the parameter storage section.
